(19) United States
(12) Patent Application Publication
(10) Pub. No.: US 2013/0008974 A1
(43) Pub. Date: Jan. 10, 2013

(54) SPRAY NOZZLE AND METHOD FOR THE PRODUCTION OF AT LEAST ONE ROTATING SPRAY JET

(76) Inventors: Hermann Lange, Metzingen (DE); Siegmar Pelz, Grabenstetten (DE)

(21) Appl. No.: 13/540,019

(22) Filed: Jul. 2, 2012

(30) Foreign Application Priority Data
Jul. 8, 2011 (DE) 102011078857.3

(51) Int. Cl. B05B 3/04

(52) U.S. Cl. 239/1; 239/240; 239/251

(57) ABSTRACT

A spray nozzle for the production of at least one rotating spray jet, comprising a housing comprising a fluid inlet and a rotor mounted for rotation on the housing and comprising at least one discharge orifice for the fluid to be sprayed, wherein a swirl chamber is provided between the housing and the rotor and wherein the fluid to be sprayed is fed to the swirl chamber by way of at least one inlet duct inclined in the required direction of rotation of the rotor, in which the inlet duct has, at its end opening into the swirl chamber, a widened portion, which widened portion of the end of the inlet duct is disposed on the counter-rotative side of that end of the inlet duct which opens into the swirl chamber.

### CROSS REFERENCE TO RELATED APPLICATION

This application claims the priority of German Application No. 10 2011 078 857.3, filed Jul. 8, 2011, the disclosure of which is hereby incorporated by reference in its entirety into this application.

### FIELD OF THE INVENTION

The invention relates to a spray nozzle for the production of at least one rotating spray jet, which spray nozzle comprises a housing comprising a fluid inlet and a rotor mounted for rotation on the housing and comprising at least one outlet orifice for the fluid to be sprayed, wherein a swirl chamber is provided between the housing and the rotor and wherein the fluid to be sprayed is fed to the swirl chamber by means of at least one inlet duct that is inclined in the required direction of rotation of the rotor.

The invention also relates to a method for the production of at least one rotating spray jet by means of a spray nozzle.

### BACKGROUND OF THE INVENTION

German Patent Specification DE 100 06 864 B4 discloses a cleaning nozzle that creates a rotating spray jet. The spray nozzle comprises a shaft-like housing that is partially surrounded by a rotor mounted for rotation on the housing. Between the housing and the rotor there is provided a swirl chamber to which fluid is fed by way of an inclined inlet duct. This causes the rotor to rotate. In order to prevent the speed of rotation of the rotor from continually increasing with increasing fluid pressure, an outlet orifice of the rotor for fluid to be sprayed is oriented at an angle of less than 90° in relation to the required direction of rotation of the rotor. As soon as the rotor rotates and fluid emerges from the outlet orifice, the emergent fluid exerts a braking effect on the rotor. Thus the speed of rotation of the rotor can be prevented from continuing to increase as the fluid pressure increases.

### SUMMARY OF THE INVENTION

It is an object of the present invention to improve a spray nozzle and a method for the production of at least one rotating spray jet.

To this end, the invention provides a spray nozzle for the production of at least one rotating spray jet, which spray nozzle comprises a housing comprising a fluid inlet and a rotor mounted for rotation on the housing and comprising at least one outlet orifice for fluid to be sprayed, wherein a swirl chamber is provided between the housing and the rotor and wherein the fluid to be sprayed is fed to the swirl chamber via at least one inlet duct that is inclined in the required direction of rotation of the rotor, and the inlet duct comprises a widened portion at its end opening into the swirl chamber. Preferably, the widened portion at the end of the inlet duct is disposed on the counter-rotative side of the inlet-duct end opening into the swirl chamber.

These measures ensure that the speed of rotation of the rotor does not continue to increase or does not increase to any great extent when the fluid pressure increases, irrespective of the orientation of the outlet orifice on the rotor. The outlet orifice or a plurality of outlet orifices can thus be disposed and oriented substantially arbitrarily, and the so-called smearing effect observed in rotating nozzles can still be prevented. This smearing effect as occurs when a rotor rotates too rapidly refers to the extremely fast sweeping movement of the spray jet over an area to be cleaned or to be coated, with the result that it is no longer possible to achieve sufficient cleaning or coating efficiency. The dwell time of the spray jet on a surface to be cleaned or coated is then too short to achieve the required effect. Although an increase in the fluid pressure in conventional rotating cleaning nozzles results in a spray jet having a greater impulse and an increased cleaning power per se, the smearing effect of such nozzles prevents satisfactory cleaning efficiency from being achieved. In the spray nozzle of the invention, as a result of the preferred arrangement of the widened portion at the end of the inlet duct on the counter-rotative side of the region in which the inlet duct opens into the swirl chamber, the fluid jets entering the swirl chamber flare in the direction contrary to the direction of rotation when the fluid pressure rises and thus generate, in the swirl chamber, components of motion of the fluid that act in the direction contrary to the direction of rotation of the rotor and thus decelerate the rotor. Thus a continual increase in the speed of rotation of the rotor when the fluid pressure rises can be prevented or reduced. However, with the spray nozzle of the invention, the configuration and arrangement of the outlet orifice or a plurality of outlet orifices on the rotor can be arbitrary, since the speed-limiting effect is achieved by the widened portion of that end of the inlet duct that opens into the swirl chamber between the housing and the rotor.

Advantageously, the widened portion extends over approximately one half of the periphery of the end of the inlet duct. The at least one inlet duct can be in the form of a bore inclined in the direction of rotation of the rotor. The bore can have a circular cross-section and the widened portion can be crescent-shaped. The widened portion can be in the form of a portion of a bore that has the same cross-section as the inlet duct but is disposed at a different angle from the inlet duct.

In this way, the widened portion can be of a comparatively simple design in that one and the same drill is used for making two bores or bore portions, each at a different angle in relation to the longitudinal center axis of the nozzle housing.

In a development of the invention, five inlet ducts are provided that are disposed at regular intervals around the longitudinal center axis of the housing and the rotor.

The five inlet ducts disposed at regular intervals around the longitudinal center axis of the housing and the rotor provide a large free flow cross-section that makes the spray nozzle of the invention less susceptible to choking effects.

In a development of the invention, the rotor is mounted for rotation on at least one bearing surface on the housing, which bearing surface is disposed at a distance from that end of the at least one inlet duct which opens into the swirl chamber.

In this way, the bearing surface is completely separate from the inlet ducts opening into the swirl chamber and thus the spray nozzle of the invention is less susceptible to choking effects. Advantageously, the bearing of the rotor on the housing is in the form of a hydrodynamic or fluid-lubricated bearing. The fluid to be sprayed will then enter the bearing gap between the housing and the rotor to ensure a substantially frictionless operation of the rotor on the housing, once the spray nozzle has been impacted by the fluid to be sprayed.

In a development of the invention, the housing is in the form of a shaft and is partially surrounded by the rotor, and the end of the housing disposed opposite to the fluid inlet is provided with a drip point.

The provision of a drip point can prevent the build-up of incrustations on the nozzle. When the fluid supply to the spray nozzle of the invention has been turned off, fluid adhering to the nozzle can drip off rapidly and centrally by way of the drip point, in order to prevent the build-up of incrustations or deposits on the nozzle.

In a development of the invention, a longitudinal center axis of a spray jet emerging from the at least one outlet orifice on the rotor is disposed such that the emergent spray jet, by virtue of its recoil force, either accelerates, or has no effect on, the rotation of the rotor.

When the outlet duct at the outlet orifice or the longitudinal center axis of the emergent spray jet is oriented at right angles to the direction of rotation of the rotor, the fluid discharged from the outlet orifice neither assists nor counteracts the rotation of the rotor. When the outlet duct at the outlet orifice or the longitudinal center axis of the emergent spray jet is oriented contrary to the direction of rotation of the rotor, the emergent fluid in fact leads to an acceleration of the rotary movement of the rotor. In this case, the torque acting on the rotor as a result of the recoil force of the emergent spray jet is the governing factor. This torque is determined by the speed and rate of flow of the fluid discharged and the lever arm of the recoil force. This lever arm is defined by the distance between the rotational axis of the rotor and a point of intersection between the longitudinal center axis of the spray jet discharged and a line proceeding radially from the center of rotation, which line and the longitudinal center axis of the spray jet intersect at right angles. In other words, the lever arm is equal to the distance between the longitudinal center axis of the spray jet and a straight line parallel thereto and intersecting the axis of rotation of the rotor. In the spray nozzle of the invention, the speed of rotation of the rotor that is desirable at a specific fluid pressure can also be adjusted by means of the orientation of the outlet orifices on the rotor or of the spray jets. The orientation of the outlet orifices or spray jets can also be configured such that they provide optimal cleaning efficiency, since the speed of rotation of the rotor is substantially independent of the orientation of the outlet orifices.

The object of the present invention is also achieved by a method for the production of at least one rotating spray jet by means of a spray nozzle comprising a housing that is immovable in relation to a fluid supply line for fluid to be sprayed, and a rotor that is mounted for rotation on the housing and that comprises at least one outlet orifice for fluid to be sprayed, which method includes the following step feeding at least one fluid jet to a swirl chamber between the housing and the rotor, wherein the longitudinal center axis of the fluid jet is inclined at an angle in the required direction of rotation of the rotor in order to cause the rotor to rotate, and wherein the angle of the longitudinal center axis is of a first size for a first fluid pressure in the supply line and the angle of the longitudinal center axis is of a second size smaller than the first for a second fluid pressure in the supply line higher than the first fluid pressure.

In this way, when the fluid pressure rises, a component of motion of the fluid jet in the direction of rotation that causes the rotor to rotate can be reduced so that it is possible to compensate the impulse of the fluid jet entering the swirl chamber, which impulse increases as the fluid pressure increases. Thus the speed of rotation of the rotor is prevented from continually increasing with increasing fluid pressure, or it is possible to restrict the increase in the speed of rotation of the rotor. In this connection, it is particularly advantageous that the speed of rotation of the rotor is thus substantially independent of the orientation of the outlet orifices and the rate of flow and speed of the fluid in the outlet orifice on the rotor. Thus the outlet orifices can be configured and disposed such that optimal cleaning or coating efficiency is achieved.

Additional features and advantages of the invention are revealed in the claims and in the following description of a preferred embodiment of the invention.

### BRIEF DESCRIPTION OF THE DRAWINGS

FIG. 1 is a partial cross-sectional side view of a spray nozzle of the invention according to a preferred embodiment;

FIG. 2 is a top view of the spray nozzle shown in FIG. 1;

FIG. 2a is a partial and diagrammatical cross-sectional view of the cross-sectional plane 2A-2A indicated in FIG. 2;

FIG. 3 is an exploded view of the spray nozzle shown in FIG. 1;

FIG. 4 is a view of a housing portion of the spray nozzle shown in FIG. 1 with emergent fluid jets indicated diagrammatically;

FIG. 5 shows the housing portion shown in FIG. 4 with the diagrammatically indicated fluid jets discharged at a higher fluid pressure than in FIG. 4;

FIG. 6 is a side view of the spray nozzle shown in FIG. 1;

FIG. 7 is a view of the cross-sectional plane A-A indicated in FIG. 6;

FIG. 8 is a side view of the spray nozzle shown in FIG. 1 at a different rotational position of the rotor from that shown in FIG. 6; and

FIG. 9 is a view of the cross-sectional plane B-B indicated in FIG. 8.

### DETAILED DESCRIPTION

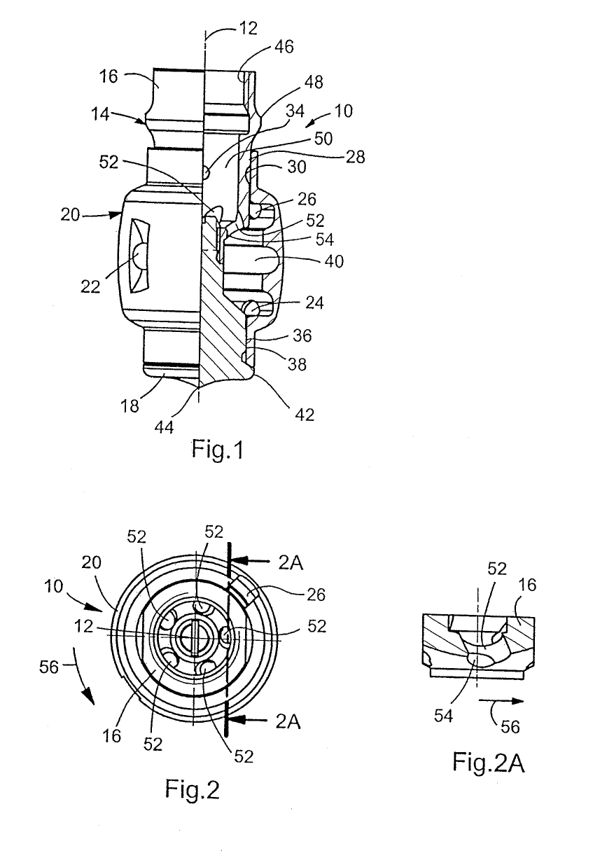

FIG. 1 illustrates a spray nozzle 10 of the invention, the spray nozzle being shown as a side view in the left half of FIG. 1 and as a cross-sectional view in the right half of FIG. 1. The cross-sectional plane shown is parallel to the drawing surface and contains the longitudinal center axis 12 of the nozzle. The spray nozzle 10 of the invention comprises a housing 14 consisting of a first housing portion disposed at the top of FIG. 1, and a second housing portion 18 disposed at the bottom of FIG. 1. The spray nozzle 10 further comprises a rotor 20 that is mounted for rotation on the housing 14 and partially surrounds the same.

The rotor 20 is provided with a plurality of outlet orifices 22, 24, and 26. The outlet orifice 22 is disposed approximately opposite to the two outlet orifices 24 and 26 on the rotor 20, as regarded in the peripheral direction of the rotor 20.

As can be seen from the right half of FIG. 1, the second housing portion 18 is screwed into a suitable female screw thread on the first housing portion 16. By means of its two portions 16, 18, the housing 14 forms a shaft that supports the rotor 20 such that the latter is captive and rotatable. For the purpose of mounting the rotor 20, the first housing portion 16 has a plain cylindrical bearing surface 28 that is provided, approximately at its center, with a peripheral groove 30 of a cross-section having the shape of a segment of a circle. Opposite to the plain cylindrical bearing surface 28, there is a similar plain cylindrical bearing surface 32 on the rotor 20. The groove 30 is supplied with fluid from the interior of the housing portion 14 by way of one or more through bores 34 so that when pressurized fluid impacts the spray nozzle 10 a fluid film is formed between the bearing surfaces 28, 32, which fluid film then ensures a substantially frictionless mounting of the rotor 20.

At its end shown at the bottom of FIG. 1, the rotor 20 is likewise provided with a plain cylindrical bearing surface 36 that is likewise opposite to a plain cylindrical bearing surface 38 on the bottom housing portion 18. A bearing gap between the bearing surfaces 36, 38 is impacted by fluid from a swirl chamber 40 disposed between the housing 14 and the rotor 20. As soon as the spray nozzle 10 is impacted by pressurized fluid, the latter flows through the bearing gap between the bearing surfaces 36, 38 and thus also ensures that the rotor 20 is mounted on the housing 14 in a substantially frictionless manner, as illustrated at the bottom of FIG. 1.

The second housing portion 18 comprises, below the rotor, a peripheral projection 42, the top surface of which serves as a stop surface for the rotor 20 to prevent the rotor 20 from slipping downwardly away from the housing 14. During the operation of the spray nozzle 10, a gap between the rotor 20 and the top surface of the peripheral projection 42 is likewise supplied with pressurized fluid so as to form a hydrodynamic and thus substantially frictionless thrust bearing between the second housing portion 18 and the rotor 20.

The second housing portion 18 is provided, at its center, with a drip point 44. Water adhering to the external surface of the housing 14 and the rotor 20 after the fluid supply to the spray nozzle 10 has been turned off is efficiently drained via this drip point 44, from which it can drip off. This largely prevents the build-up of incrustations or deposits on the external surface of the spray nozzle 10 that would result from the presence of liquid residues.

The first housing portion 16 is provided with a female screw thread 46 for screwing in a fluid supply line. Directly below or downstream of the female screw thread 46, the external surface of the first housing portion 16 displays a peripheral projection 48 that is larger than the inside diameter of the rotor 20. Thus the rotor 20 can slide neither upwardly nor downwardly from the housing 14 in the mounted state of the spray nozzle 10.

For the purpose of mounting the three-part spray nozzle 10, the rotor 20 is first pushed over the bearing surface 28 on the first housing portion 16 from the bottom end thereof, as illustrated in FIG. 1. The second housing portion 18 is then inserted into the rotor 20 from the bottom end thereof and screwed to the first housing portion 16 until the two bearing surfaces 36, 38 are opposite each other.

The first housing portion 16 comprises an inlet chamber 50 disposed downstream of the female screw thread 46. Radial bores 34 lead from the inlet chamber 50 to supply liquid to the groove 30 in the bearing surface 28 on the first housing portion 16. A total of five inlet ducts 52 leading from the inlet chamber 50 in the first housing portion 16 connect the inlet chamber 50 to the swirl chamber 40 between the housing 14 and the rotor 20. The inlet ducts 52 are inclined in the required direction of rotation of the rotor 20 so that the fluid in the swirl chamber 40 circulates in the required direction of rotation of the rotor 20 to entrain the rotor and cause it to rotate.

That end of the inlet duct 52 which is located in the region in which the inlet duct opens into the swirl chamber 40 is provided with a widened portion 54 that is only partially visible in FIG. 1 and is disposed at that end of the inlet duct which opens into the swirl chamber on the counter-rotative side but extends in both peripheral directions through an angle of more than 90° proceeding from the center of the side of the said inlet-duct end. Only the center, as regarded in the peripheral direction, at which the widened portion 54 has its maximum radial extent, is disposed on the counter-rotative side of the inlet-duct 52 end opening into the swirl chamber 40. When the pressure of the fluid increases, the direction of the fluid jet entering the swirl chamber 40 from the inlet duct 52 alters as a result of this widened portion to the effect that the angle at which this fluid jet is inclined in the direction of rotation of the rotor 20 decreases. This is because the fluid jet fills the widened portion completely as the pressure increases and it widens, as a result of the widened portion, on one side in a direction that is not in the direction of rotation of the rotor and that may be contrary thereto. As a result, that component of motion of the fluid jets entering the swirl chamber 40 from the inlet ducts 52 which is directed in the direction of rotation of the rotor 20 decreases as the pressure of the fluid increases. This prevents a continual increase in the speed of rotation of the rotor 20 in spite of the increasing pressure on the fluid.

FIG. 2 shows the spray nozzle 10 illustrated in FIG. 1 in a view taken from above, that is, into the interior of the first portion 16 of the housing 14. It can be seen from the figure that, in all, five inlet ducts 52 are disposed at regular intervals around the longitudinal center axis 12 of the spray nozzle 10 and these inlet ducts 52 are inclined in the direction of rotation of the rotor 20. The desired direction of rotation of the rotor 20 is indicated by a curved arrow 56.

The outlet orifice 26 in the top region of the rotor 20 is also visible in the illustration shown in FIG. 2.

FIG. 2A is a partial and diagrammatical view of the cross-sectional plane 2A-2A indicated in FIG. 2. FIG. 2A serves only to illustrate the shape of the inlet duct 52 and the arrangement of the widened portion 54 at that end of the inlet duct 52 which opens into the swirl chamber 40. As can be seen from FIG. 2A, the inlet ducts 52 are inclined in the direction of rotation of the rotor 20. The direction of rotation of the rotor 20 is again indicated by the arrow 56. At that end of the inlet duct 52 which opens into the swirl chamber 40 and which is shown at the bottom of FIG. 2A, there is provided the widened portion 54, of which the maximum extent in the radial direction of the inlet duct is on the counter-rotative side of the inlet duct 52 contrary to the direction of rotation 56. The widened portion then tapers off on both sides and thus extends at the end of the inlet duct 52 opening into the swirl chamber 40 approximately along half of the periphery of the inlet duct 52. The widened portion 54 is in the form of a bore portion and has the same circular diameter as the inlet duct 52. However, the widened portion 54 is provided in the form of a bore portion at a different angle from the inlet duct 52.

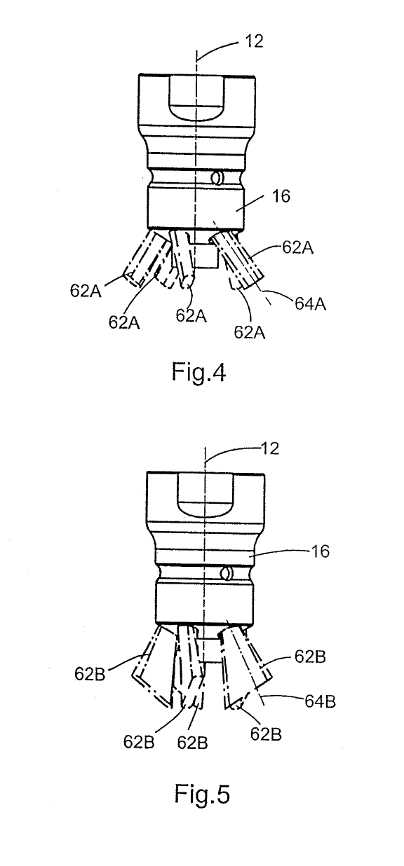

As explained above and as is discernable from FIGS. 4 and 5, the provision of the widened portion 54 alters the shape and orientation of a fluid jet entering the swirl chamber 40 from the inlet ducts 52 as the pressure of the fluid to be sprayed changes.

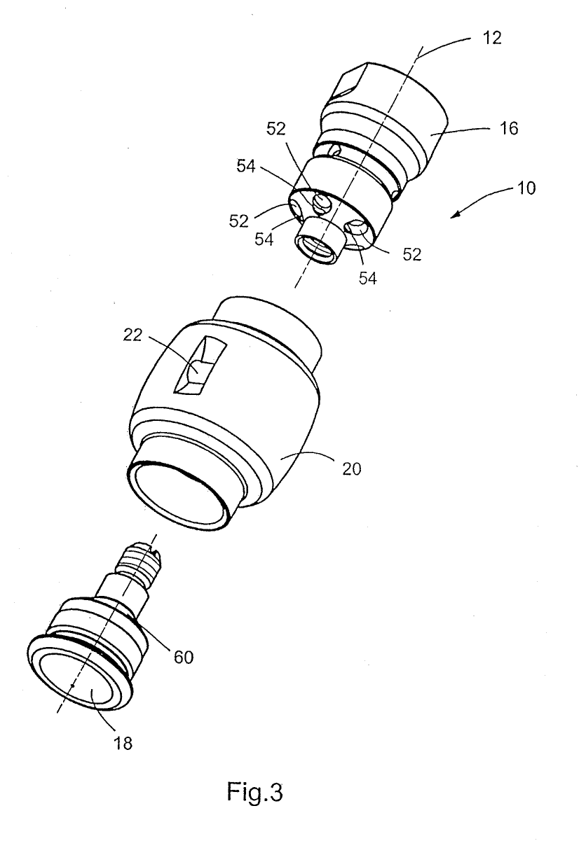

FIG. 3 is an exploded view of the spray nozzle 10 shown in FIG. 1. The first housing portion 16, the second housing portion 18, and the rotor 20 are visible in the figure. FIG. 3 also shows the inlet ducts 52, which are offset tangentially from the longitudinal center axis 12 of the spray nozzle 10 and are inclined in the direction of rotation of the rotor 20. Each of the widened portions 54 is disposed at that end of the inlet duct which is visible in FIG. 3 and opens into the swirl chamber 40 between the housing 14 and the rotor 20. The inlet ducts 52 comprising the widened portions 54 are disposed in a conical bevel of the first housing portion 16. The inlet ducts 52 comprising the widened portions 54 are shaped and disposed such that a slightly fanned jet emerges therefrom and impacts the internal wall of the rotor 20 to cause the same to rotate.

It can also be seen from the illustrations shown in FIG. 1 and FIG. 3 that the outlet orifice 22 in the rotor 20 is formed by intersection of a peripheral groove having a cross-section similar to a segment of a circle on the internal surface of the rotor 20 and a cut produced on the external surface of the rotor 20 by means of a side milling cutter.

The swirl chamber comprises, on the one hand, the conical bevel on the first housing portion 16 at which the inlet ducts 52 terminate and, on the other hand, a conical bevel 60 on the second housing portion 18 disposed opposite to the conical bevel on the first housing portion 16.

FIG. 4 shows only the first housing portion 16, and diagrammatically indicates the shape of fluid jets 62A that are discharged from the inlet ducts 52 and that enter the swirl chamber 40. FIG. 4 shows the state of the fluid jets at a first fluid pressure. It can be seen from the figure that the fluid jets 62A are only slightly fanned and exhibit an approximately oval cross-section. The center axis 64A of the fluid jets 62A is disposed in the projection shown in FIG. 4 at a first angle relative to the longitudinal center axis 12 of the housing portion 16.

FIG. 5 shows the first housing portion 16 and the fluid jets 62B discharged at a second fluid pressure that is higher than the first fluid pressure relevant to FIG. 4. The fluid jets 62B are now fanned to a greater extent, but still have an approximately oval cross-section. It can be seen from the figure that an angle between the longitudinal center axis 12 of the first housing portion 16 and the center axis 64B of the fluid jets 62B is smaller than the corresponding angle shown in FIG. 4. Thus the component of motion in the direction of rotation of the rotor 20 at a low fluid pressure, as illustrated in FIG. 4, is greater than the component of motion in the direction of rotation of the rotor 20 at a higher fluid pressure, as illustrated in FIG. 5. In spite of the greater impulse of the fluid jets 62B as a result of the higher fluid pressure, the torque acting on the rotor 20 increases insignificantly or not at all, so that no continually increasing speed of the rotor 20 is observable when the fluid pressure increases. As explained above, this effect is the result of the widened portions 54 at that end of the inlet ducts 52 which opens into the swirl chamber 40.

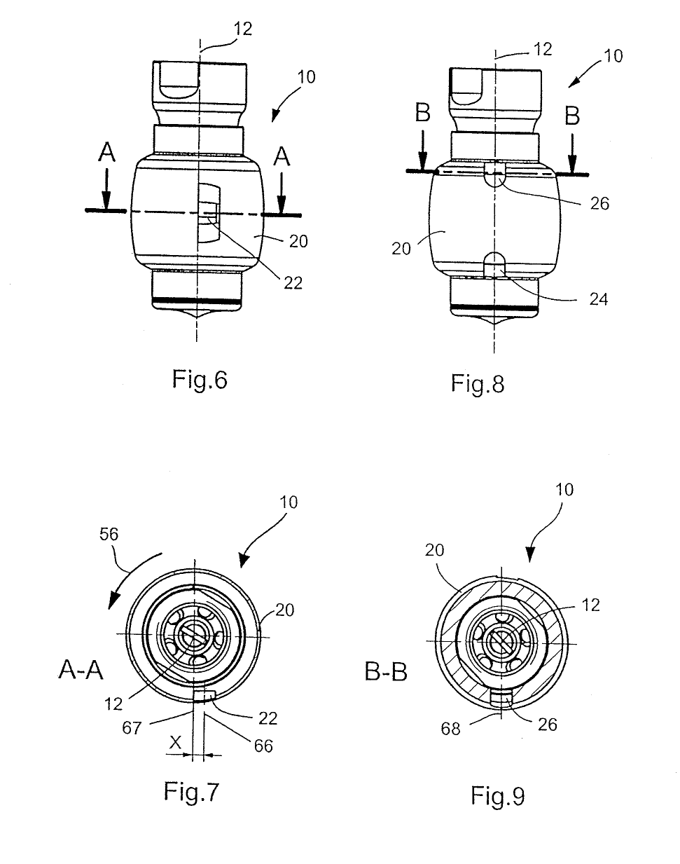

FIG. 6 shows the spray nozzle 10 illustrated in FIG. 1 as a side view and at a first rotational position at which the outlet orifice 22 is visible.

FIG. 7 is a view of the cross-sectional plane A-A indicated in FIG. 6. It is discernable from the figure that the outlet orifice 22 is oriented such that its center axis 66 is at right angles to the direction of rotation of the rotor 20 and is tangentially offset in the direction of rotation of the rotor 20, the direction of rotation of the rotor 20 being indicated by the curved arrow 56. Fluid discharged in the form of a spray jet from the outlet orifice 22 thus causes, by way of its recoil force, rotation of the rotor 20, since the center axis 66 which in this case coincides with the longitudinal center axis of a spray jet discharged from the outlet orifice 22, is disposed at a distance X from a parallel straight line 67 that intersects the rotation axis 12 of the rotor 20. The distance X corresponds to the lever arm by means of which the recoil force of the spray jet discharged from the outlet orifice 22 generates a torque on the rotor 20.

FIG. 8 is a side view of the spray nozzle 10 shown in FIG. 1 at a second rotational position of the rotor 20 that differs from the rotational position shown in FIG. 6. The two outlet orifices 24 and 26 are visible in this side view. The outlet orifice 24 produces a spray jet that is oriented downwardly in FIG. 8, whereas the outlet orifice 26 produces an upwardly oriented spray jet in the illustration shown in FIG. 8. Together with the outlet orifice 22, the spray nozzle 10 of the invention can thus cover a spray angle of approximately 180°. Due to the fact that the rotor 20 rotates about the longitudinal center axis 12, it is possible, for example, to clean the entire interior of a tank surrounding the spray nozzle 10.

FIG. 9 is a view of the cross-sectional plane B-B indicated in FIG. 8. It can be seen from FIG. 9 that the center axis 68 of the outlet orifice 26 and the center axis of the outlet orifice 24 (not visible in FIG. 9) extend exactly radially in relation to the longitudinal center axis 12 of the spray nozzle 10. Thus the spray jets discharged from the outlet orifices 24, 26 are conducive to causing rotation of the rotor 20 but have no decelerating effect thereon. The outlet orifices 24, 26, 22 can be oriented and disposed substantially arbitrarily in the spray nozzle 10 of the invention and they can be configured so as to obtain optimal cleaning results. Control of the speed of rotation of the rotor 20 is achieved, as explained above, by the special shape of the inlet ducts 52 comprising the widened portions 54.

1. A spray nozzle for the production of at least one rotating spray jet comprising a housing comprising a fluid inlet and a rotor mounted on said housing and comprising at least one discharge orifice for fluid to be sprayed, wherein a swirl chamber is formed between said housing and said rotor and wherein said fluid to be sprayed is fed to said swirl chamber, by way of at least one inlet duct inclined in the required direction of rotation of said rotor, wherein said inlet duct has a widened portion at that end thereof which opens into said swirl chamber.

2. The spray nozzle as defined in claim 1, wherein said widened portion of said end of said inlet duct is disposed on the counter-rotative side, with reference to the direction of rotation of said rotor, of that end of said inlet duct which opens into said swirl chamber.

3. The spray nozzle as defined in claim 1, wherein said widened portion extends over approximately one half of the periphery of said end of said at least one inlet duct.

4. The spray nozzle as defined in claim 1, wherein said at least one inlet duct is in the form of a bore inclined in the direction of rotation of said rotor.

5. The spray nozzle as defined in claim 4, wherein said bore has a circular cross-section and said widened portion is crescent-shaped.

6. The spray nozzle as defined in claim 5, wherein said widened portion is in the form of a portion of a bore having the same cross-section as said inlet duct but disposed at a different angle from said inlet duct.

7. The spray nozzle as defined in claim 1, wherein there are provided five inlet ducts that are disposed at regular intervals around said longitudinal center axis of said housing and said rotor.

8. The spray nozzle as defined in claim 1, wherein said rotor is mounted for rotation on at least one bearing face on said housing, wherein said bearing face is set at a distance from that end of said at least one inlet duct which opens into said swirl chamber.

9. The spray nozzle as defined in claim 1, wherein said housing is in the form of a shaft and is partially surrounded by said rotor, wherein that end of said housing which is opposite to said fluid inlet is provided with a drip point.

10. The spray nozzle as defined in claim 1, wherein a longitudinal center axis of a spray jet emerging from said at least one discharge orifice on said rotor is disposed such that an emergent spray jet either accelerates the rotation of said rotor, due to its recoil force, or has no influence thereon.

11. A method for the production of at least one rotating spray jet by means of a spray nozzle comprising a housing, which is immovable in relation to a supply line for the fluid to be sprayed, and a rotor mounted for rotation on said housing and comprising at least one discharge orifice for the fluid to be sprayed, which method includes the following step: feeding at least one fluid jet to a swirl chamber between said housing and said rotor, wherein a longitudinal center axis of said fluid jet is inclined at an angle in the required direction of rotation of said rotor in order to rotate said rotor, and wherein at a first fluid pressure in said supply line the angle of said longitudinal center axis is of a first size, and at a second fluid pressure in said supply line, which is greater than said first fluid pressure, the angle of said longitudinal center axis is of a second size, which is smaller than said first size.
